(19) United States
(12) Patent Application Publication
(10) Pub. No.: US 2013/0326887 A1
(43) Pub. Date: Dec. 12, 2013

(54) Trimmer Shield

(71) Applicant: James Swan, Claysville, PA (US)

(72) Inventor: James Swan, Claysville, PA (US)

(21) Appl. No.: 13/907,941

(22) Filed: Jun. 2, 2013

Related U.S. Application Data
(60) Provisional application No. 61/655,584, filed on Jun. 5, 2012.

(51) Int. Cl. A01D 34/416

(52) U.S. Cl. CPC A01D 34/4167
USPC 30/286

(57) ABSTRACT

A clear, shaft-mounted, shield for a String Trimmer , Brush Cutter, Pole Trimmer or similar shaft-based cutting device which provides debris protection for the operator. This invention defines the usage of a transparent and rigid material which absorbs & deflects high-speed flying debris generated from the spinning head of trimming devices. This invention will function as expansive layer of protection used separately or in conjunction with existing, head-mounted, trimmer guards and improves upon the debris protection, visibility, adjustment and removal compared with conventional, fixed and opaque guards, which are the standard of lawn trimmer devices.

### BRIEF SUMMARY OF THE INVENTION

This original trimmer shield is composed of a rigid, impact adsorbing, transparent material such as acrylic or polypropylene, or similar rigid and clear (or slightly translucent) material.

The shield offers a quick clip to the trimmer shaft or similar yard device for easy on/off/adjustments and speedy shaft position compensations for optimum protection and removal.

This shield structure and chosen material affords both above and below the shaft protection providing the user an expanded range of protection while offering a clear view of the cutting area.

This invention features an auto-leveling, pivot benefit at the point of the shaft attachment, allowing for rotation of the trimmer head from trim mode to edging mode while providing the maximum, continuous coverage between the shaft and the ground surface.

This design incorporates the advent of two rigid flaps in a continuous barrier configuration and a specialized one-way hinge for compensation of ground irregularities, including prevention of the shield from flexing or collapsing forward and thus inhibiting trimmer line travel , particularly, during down slope or off horizontal operation. Additionally, the backward articulations of the adjacent flaps facilitate additional impact absorption and under obstruction access. The hinge is designed to remain protected from debris and subsequent trimming buildup due to a novel behind-the-shield mounting method.

### BRIEF DESCRIPTION OF THE DRAWINGS

The exact nature of this invention, as well as the objects and advantages thereof, will become readily apparent from consideration of the following specification in conjunction with the accompanying drawings.

FIG. 1: Shield and Hinge (front, side, top). This is the portion of the shield composed of a rigid, transparent material with the intention of both protecting the trimmer user from high-speed flying debris while permitting the full unobstructed view of string efficacy or cutting head operation. The shield's rigid material, clarity, orientation and shape provide the user, specifically, solid above and below shaft protection.

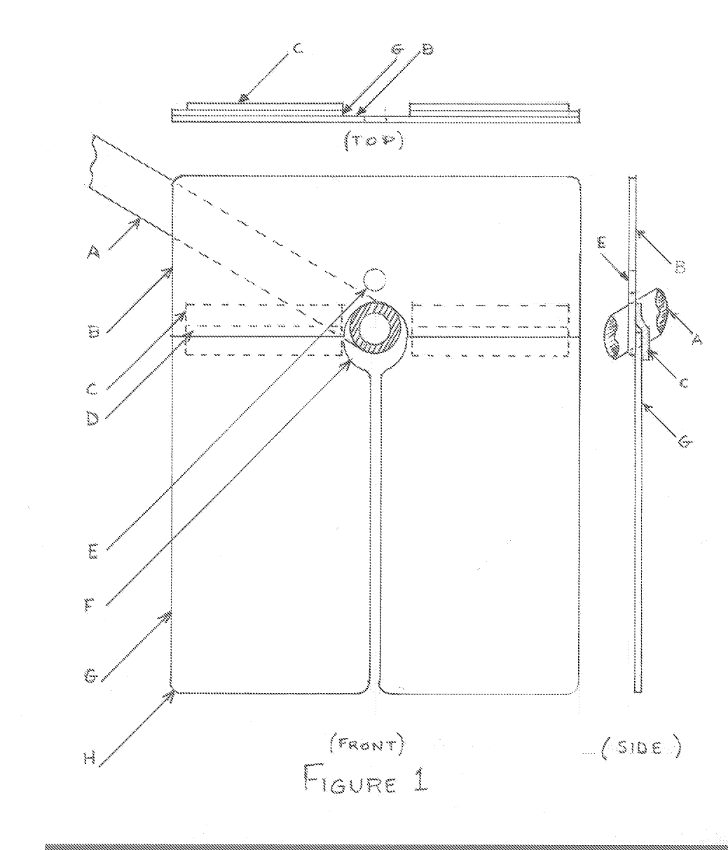

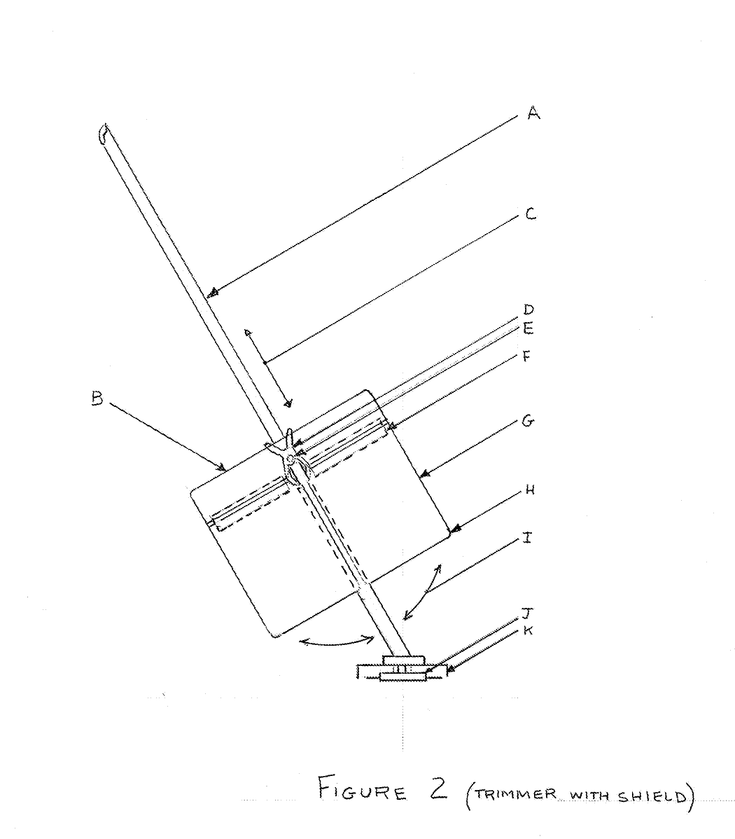

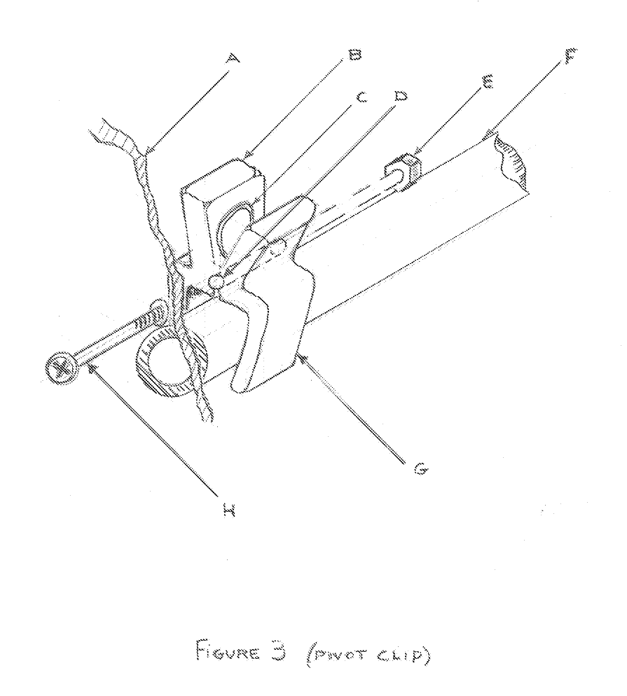

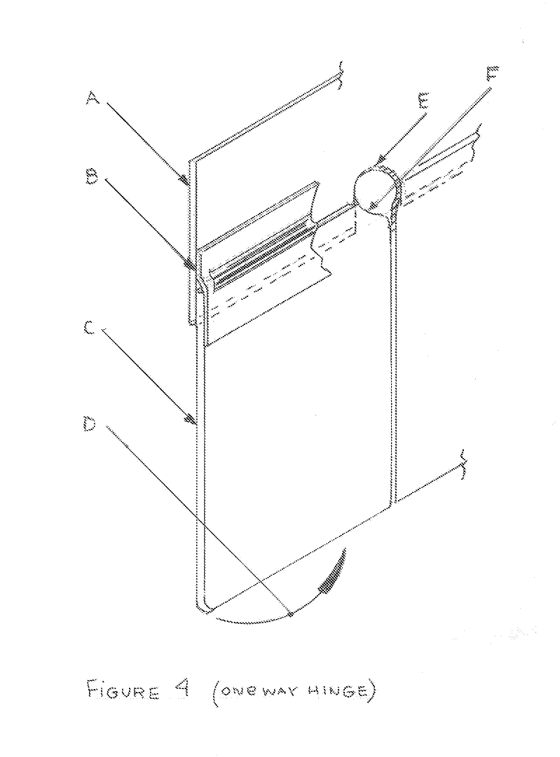

For FIG. 1
1) Item B: The Upper Shield. The Upper portion extending the width of the device, this portion rest upon the trimmer's shaft (A) upon the universal arch cut out (E) and features the centrally located through hole (E) for the balanced mounting of the pivot of FIG. 3.
2) Item G: The Independent Flaps. These extend the shield to ground level and feature unobstructed views along with independent hinged articulation at (C). The adjacent alignment of the two, clear debris flaps afford a continuous blocking protection wall. The flaps move independently permitting quick attachment and compensation for ground irregularities. The rigid, clear flaps feature a curved corner design (H).
3) Item C: The One-way Hinge. This hinge, on each flap, offers the backward movement (towards the operator) of the rigid independent flaps (G) while preventing the forward swing (towards trimmer head) of the protective material. The rigid nature and unidirectional movement prevent the guard from interfering, collapsing and obstructing the movement of the trimmer's spinning head, lines or blades. This element permits down slope embankment and odd angle trimming protection to be optimally maintained.

FIG. 2: Shield on a Trimmer (Mounted, front view). This is a view to demonstrate the mounting position and general orientation for how the shield (G) will fit upon a trimmer with an existing guard (K).

For FIG. 2
1) Item B: The Upper Shield. The Upper shield portion extending the width of the device, this portion rest upon the trimmer's shaft (A) and may be positioned about the vertical range of motion (C).
2) Item G: The Independent Flaps. These extend the shield to ground level and feature unobstructed views along with one-way hinged articulation at (F). The adjacent alignment of the two, clear debris flaps afford a continuous blocking protection wall. The clear flaps move independently permitting rapid attachment and compensation for ground irregularities. The rigid, clear flaps feature a curved corner design (H) for reduced lateral resistance to ground based obstacles.
3) Item D: The Pivot Clip. The shield clip will mount to a variety of trimmer shafts having varying diameters. The clip (D) utilizes the employment of a one-handed squeezable clip (detailed in FIG. 3) which will grip a straight or curved trimmer shaft (A). This clip features a center axis (E) for balanced, independent movement and self-leveling ground alignment, with gravity, occurring at the point of attachment to (item B). The quick clip is mounted in such a way as to permit lateral (side-to-side) swinging motion (I) of the entire unit. The novel squeeze clip attachment point establishes the preferred user height positioning of the shield (C) on the shaft and the rapid attachment, adjustment & removal of the shield for maintenance, trimmer starting and extended storage.

FIG. 3: Pivot Clip (2D view). This is a view to demonstrate the pivot mount to the shield surface and the method of attachment to a trimmer's shaft.

For FIG. 3
1) Item A: The Upper Shield (cut-away). This is a partial view of the clear shield's surface and position as it relates to the pivot clip (G) and the Trimmer shaft (F).
2) Item B: The Pivot Clip. The shield clip will mount to a variety of trimmer shafts having varying diameters. The clip utilizes the employment of a one-handed squeezable end (B) which will grip a straight or curved trimmer shaft (F). This clip features a center axis bolt (H) mounted through the upper shield and clip at (D) and retained with nut (E) for balanced, free-range, lateral movement of the shield (A).
3) Item C: The Clip Spring. The spring is incorporated into the clip and provides constant pressure for universally curved clamp prong (G) and permits the quick release feature to benefit the operator's rapid mounting, removal and adjustment.

FIG. 4: Shield Hinge Detail (Side View 2D). This is a view to demonstrate the method for mounting the flaps to the Shield's upper section using a protected, one-way articulating hinge.

For FIG. 4
1) Item A: The Upper Shield. This is a partial view of the clear shield as it relates to the protected, unidirectional hinge (B) and the articulating shield flap (C).
2) Item B: The One-way Flex Hinge. The shield clip will mount to a variety of trimmer shafts having a varying of diameters via universal arch (E) and Flap's ease curve (F).
3) Item C: The Articulating Flap. The clear, rigid flap provides full view of trimmer head and cutting surfaces and articulates about a unidirectional hinge (B) in a range of motion (D).

### DETAILED DESCRIPTION OF THE PREFERRED EMBODIMENTS

Reference will now be made to the preferred embodiments of the invention, examples of which are illustrated in the accompanying drawings. While the invention will be described in conjunction with the preferred embodiments, it will be understood that these embodiments are not intended to limit the invention. On the contrary, the invention is intended to cover alternatives, modifications and equivalents, which may be included within the spirit and scope of the invention as defined by the appended claims. In the following detailed description, numerous specific details are set forth in order to provide a thorough understanding of the present invention. However, it will be understood by one of ordinary skill in the art that the present invention may be practiced without these specific details. In other instances, well known methods, procedures, and components have not been described in detail so as not to unnecessarily obscure the important aspects of the present invention.

This clear trimmer shield (FIG. 1) is composed of a rigid, impact resistant, transparent material such as acrylic or polypropylene, or similar rigid and clear (or slightly translucent) material. The rigid nature of the material allows for the above and below shaft protective functionality. The clear nature of the invention's material permits the full, unobstructed, view of the trimmer's operation. The mounting location and method may be altered without altering the clear-view spirit of this invention.

The trimmer shield offers a quick clip (FIG. 3) to the trimmer shaft for easy on/off/adjustments and speedy shaft location compensations (FIG. 2c) for optimum protection and removal. The specialized, one-handed, quick clip is squeezed to release the clip's grabbing force against the trimmer shaft. The clip design may vary without altering the spirit of the invention.

This shield's expansive shape and material affords both above and below the shaft protection providing the user an increased range of debris protection. The physical shape, mounting position and scale of the main shield body and flap(s) may vary without altering the spirit of the invention.

This invention features a, unique, auto-leveling benefit at the point of the shaft-to-clip attachment (depicted in FIG. 2), allowing for rotation of the trimmer head from trim mode to edging mode while providing the maximum, continuous coverage between the shield's lower edge and the ground surface.

This design incorporates the advent of two rigid flaps in a continuous barrier configuration and a specialized one-way hinge (FIG. 4) for compensation of ground irregularities including prevention of the shield from flexing or collapsing forward and thus inhibiting trimmer line travel, particularly, during down slope or off horizontal operation. Additionally, the backward articulations of the adjacent flaps (FIG. 4d) facilitate improved impact absorption. The hinge is designed to remain protected from debris and subsequent debris buildup via a novel, behind-the-shield, mounting method (shown in FIG. 4 & FIG. 1-side view). This location, design and flexible material permits all required motions of the independent flaps. In the preferred embodiment the flexible hinge material will be clear or largely translucent. The location, chosen material or presence of the hinge itself may vary without altering the spirit of the invention.

The foregoing description should be considered as illustrative of the principles and essential form of the invention. Since modifications and changes could readily occur to those skilled in the art, it is not desired to limit the invention to the exact construction and operation shown and described, and, accordingly, all suitable modifications and equivalents may be resorted to, falling within the scope of the invention.

What is claimed is:

1. A shield as a means of protection for the user of a String trimmer or similar pole-based cutting device where the bulk of the shield is to be a transparent, or mainly clear, barrier of rigid material composed of acrylic or polypropylene or similarly impact resistant material that will permit unobstructed views of the trimmer head area and views of the yard.

2. The Shield of claim 1, wherein the rigid body material of the shield affords above and below the shaft protection as mounted to the trimming device.

3. The Shield of claim 1, wherein the shape, orientation and rigid character of the clear material provides increased independent or improved supplemental protection, when mounted about the trimmer's shaft in a vertical or nearly vertical plane.

4. The Shield of claim 1, wherein the lower portion is comprised of an independent flap or plural flaps comprised as a nearly continuous protective barrier, and articulates in a manner to allow for rapid shaft mounting, position adjustments and quick removal from a trimming device.

5. The Shield of claim 1, wherein the flaps of claim 4 are of similar size and weight providing the necessary balance for self-leveling and lateral pivot functionality, including the rotation of the trimmer into an edging orientation.

6. The Shield of claim 1, wherein the lower flaps of claim 4 are mounted with a one-directional hinge permitting a flap to move, only toward the operator, thus mitigating the force of flying debris, yet preventing the forward movement of a flap from impeding the trimmer or brush cutter's cutting mechanism and head movement.

7. The Shield of claim 1, wherein the outer curved edges of the shield's rigid material minimize resistance to ground irregularities as the trimmer passes, side to side, over land during operation.

8. The Shield of claim 1, wherein the central cutout of the shaft-mount portion will be of sufficient size and curvature to accommodate various manufacturer's trimmer shafts having differing diameters and facilitating the lateral pivot motion of the shield itself.

9. The Shield of claim 1, wherein the shield will have affixed a spring reinforced quick clip or shaft clamp to facilitate rapid attachment, adjustment and immediate removal of the entire shield for cleaning and readily maintaining the clear, protective device.

10. The Shield of claim 1, wherein the clip of claim 9 will be affixed in such a manner to shield of claim 1 as to allow for both natural gravitational balance and laterally induced movement about a pivot point between the shield unit and shaft.
